(19) United States
(12) Patent Application Publication
(10) Pub. No.: US 2024/0424404 A1
(43) Pub. Date: Dec. 26, 2024

(54) METHOD AND SYSTEM FOR MIXED-REALITY RACE GAME AND BROADCASTING

(71) Applicant: Sunburn Capital L.L.C-FZ, Dubai (AE)

(72) Inventors: Mikko Spoof, Dubai (AE); Lauri Koutaniemi

(21) Appl. No.: 18/820,684

(22) Filed: Aug. 30, 2024

Related U.S. Application Data
(63) Continuation of application No. PCT/IB2024/054929, filed on May 21, 2024.

(30) Foreign Application Priority Data
May 26, 2023 (FI) 20235584
Jul. 26, 2023 (FI) 20235839

(51) Int. Cl. A63F 13/65; A63F 13/216; A63F 13/52; A63F 13/803

(52) U.S. Cl. CPC A63F 13/65; A63F 13/216; A63F 13/52; A63F 13/803

(57) ABSTRACT

The present disclosure relates to systems and methods for a mixed-reality race game in a virtual racing environment having a virtual racetrack representing a real-world racetrack. Telemetry data from a real-world racer car moving on the real-world racetrack is received to determine a position and speed of a corresponding virtual racer car model on the virtual racetrack. Control data associated with a controllable virtual racer car is received from a user device. A video item associated with a geolocation location of the user device is fitted to the virtual racer car model. A position and speed of the controllable virtual racer car in the virtual racetrack is calculated based on the control data, and a visual representation of the mixed-reality race game is produced and displayed, including the virtual racing environment together with the controllable virtual racer car and the controllable virtual racer car.

### CLAIMS TO PRIORITY

This application claims priority to PCT Application Number PCT/IB2024/054929 filed on 21 May 2024, which claims priority to Finnish Application FI-20235839, 26 Jul. 2023 and to Finnish Application FI-20235584 filed on 26 May 2023, each of which is herein incorporated by reference in its entirety.

### FIELD

The present disclosure relates to a method for mixed-reality race game and to providing real-world racing data for the game.

### BACKGROUND

In race games played with computer system users playing the game are configured to play against other players in a multiplayer game. This may require that the race games need multiple players at the same time in order to play the game against other human players. Additionally, the content within the game may be the same for all the player despite location of the players. Thus, it would be beneficial to have more flexibility and customizations options while still allowing good user experience for a player.

### BRIEF DESCRIPTION

The scope of protection sought for various embodiments is defined by the independent claims. Dependent claims define further embodiments included in the scope of protection. Exemplary embodiments, if any, that do not fall into any scope of protection defined in the claims, are to be considered as examples useful for understanding the cope of protection.

According to a first aspect there is provided a computer-implemented method comprising for a mixed-reality race game, the method comprising: providing a virtual racing environment comprising a virtual racetrack, the virtual racetrack being a virtual representation of a real-world racetrack, providing a virtual racer car model representing a real-world racer car, providing a controllable virtual racer car, receiving telemetry data from the real-world racer car moving on the real-world racetrack, the telemetry data comprising at least position data and motion data of the real-world racer car, and associating telemetry data of the real-world racer car with the virtual racer car model, receiving, from a user device, control data associated with the controllable virtual racer car, and user data comprising geolocation information of the user device the geolocation information defining geographical location of the user device, obtaining a video item associated with the geolocation information and profile of the real-world racer car, fitting the video item on the virtual racer car model representing the real-world racer car, calculating position and speed of the virtual racer car model in the virtual racetrack based on the telemetry data, calculating position and speed of the controllable virtual racer car in the virtual racetrack based on the control data, generating a visual representation of the mixed-reality race game comprising the virtual racing environment together with the controllable virtual racer car in the virtual racetrack, wherein the visual representation is generated at least partly based on the determined position and speed of the virtual racer car model and the determined position and speed of the controllable virtual racer car.

According to a second aspect there is provided a computer program product comprising instructions, which, when executed by a computer system, cause the computing device to perform a computer-implemented method according to the first aspect.

According to a third aspect there is provided a non-volatile computer-readable medium comprising program instructions stored thereon which, when executed on a computer system, cause the computer system to perform a computer-implemented method according to the first aspect.

According to a fourth aspect there is provided a system for mixed-reality race game, the system comprising a computer system comprising instructions which when executed on at least one processor of the computer system cause the computer system to perform mixed-reality race game, and a user device connectable to the computer system, wherein the computer system is configured to: provide a virtual racing environment comprising a virtual racetrack, the virtual racetrack being a virtual representation of a real-world racetrack, provide a virtual racer car model representing a real-world racer car, provide a controllable virtual racer car, receive telemetry data from the real-world racer car moving on the real-world racetrack, the telemetry data comprising at least position data and motion data of the real-world racer car, and associating telemetry data of the real-world racer car with the virtual racer car model, receive, from a user device, control data associated with the controllable virtual racer car, and user data comprising geolocation information of the user device the geolocation information defining geographical location of the user device, obtain a video item associated with the geolocation information and profile of the real-world racer car, fit the video item on the virtual racer car model representing the real-world racer car, calculate position and speed of the virtual racer car model in the virtual racetrack based on the telemetry data, calculate position and speed of the controllable virtual racer car in the virtual racetrack based on the control data, generate a visual representation of the mixed-reality race game comprising the virtual racing environment together with the controllable virtual racer car in the virtual racetrack, wherein the visual representation is generated at least partly based on the determined position and speed of the virtual racer car model and the determined position and speed of the controllable virtual racer car.

### BRIEF DESCRIPTION OF THE DRAWINGS

FIG. 1 illustrates schematically an example of a real-world racing event such as a car race event.

FIG. 2 illustrates schematically an example of a real-world racer car.

FIG. 3 illustrates schematically the racer data unit.

FIG. 4 illustrates schematically examples of different user devices.

FIG. 5 illustrates schematically examples of different user devices.

FIG. 6 illustrates an exemplary embodiment of a system.

FIG. 7 illustrates an exemplary embodiment of a system.

FIG. 8 illustrates a schematic configuration example of the software module which may operate the computer system.

FIG. 9 illustrates schematically an example of a 2-dimensional visual representation a mixed-reality race game.

FIG. 10 illustrates schematically an example of a 3-dimensional visual representation a mixed-reality race game.

FIG. 11 illustrates a flow chart according to an exemplary embodiment.

FIG. 12 illustrates schematically an exemplary embodiment of a system.

FIG. 13 illustrates schematically an exemplary embodiment of a system.

FIG. 14 illustrates schematically an exemplary embodiment of a database structure.

FIG. 15 illustrates fitting a generated video item on a representation of a real-world racer car.

FIG. 16 illustrates an exemplary embodiment in which the video item is a three-dimensional image element configured to correspond the shape of the racer car or part of the shape of the racer car.

FIG. 17 illustrates a further exemplary embodiment, in which the racer car database and the car profile data comprises the three-dimensional car model representing the racer car.

### DETAILED DESCRIPTION

Mixed-reality offers many possibilities for immersive user experiences. For example, a user may be able to experience more than just watching a race event, such as a car race event. For example, a user may experience a car racing game in a more immersive manner by having input from a real-world race car event allowing the user feel as if being part of the real-life race event. The exemplary embodiments discussed below enable achieving the benefits of better user experience achieved with mixed-reality.

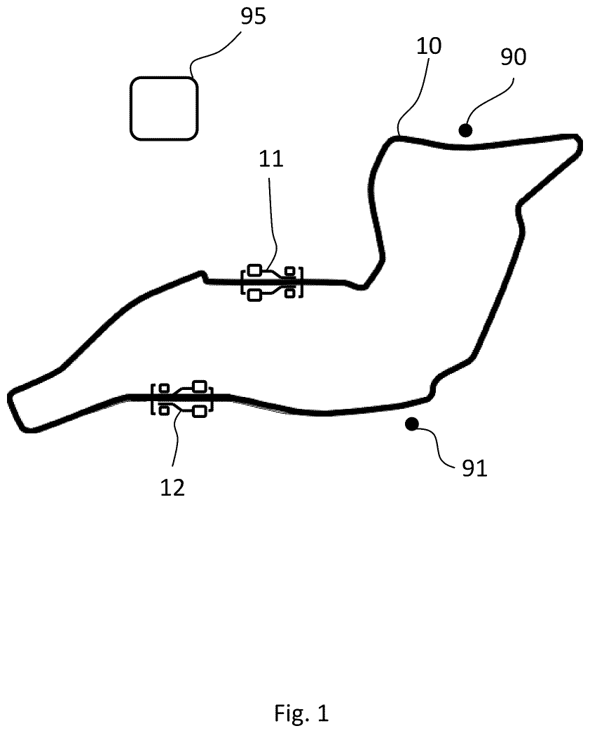

FIG. 1 illustrates schematically an example of a real-world racing event such as a car race event. The real-world racing event is carried out in a real-world racetrack 10. One or more real-world race cars 11, 12 are moving in or along the real-world racetrack 10 during the car race event. The real-world racetrack 10 may be any racetrack having a defined physical shape and length, for example, a motor sport racetrack. The real-world racetrack 10 may be an unending racetrack forming a loop or a lap, or, alternatively, may be a racetrack comprising a start and finish provided in different geographical locations.

The real-world racer car 11, 12 comprises, or is provided with, one or

more sensors configured to detect parameters of the real-world racer cars 11, 12 to generate telemetry data based on the detected parameters during the movement of the real-world racer car 11, 12 in or along the real-world racetrack 10. The detected parameters comprise at least position and motion of the real-world racer car 11, 12 detected by the one or more sensors. In the context of this application telemetry data may be understood as data of the real-world racer collected with the one or more sensors provided to, or in connection with, the real-world racer car 11, 12 during the movement of the real-world racer car 11, 12 in the real-world racetrack 10. The telemetry data may comprise at least position data and motion data of the real-world racer car 11, 12 measured with the one or more sensors provided to, or in connection with, the real-world racer car 11, 12.

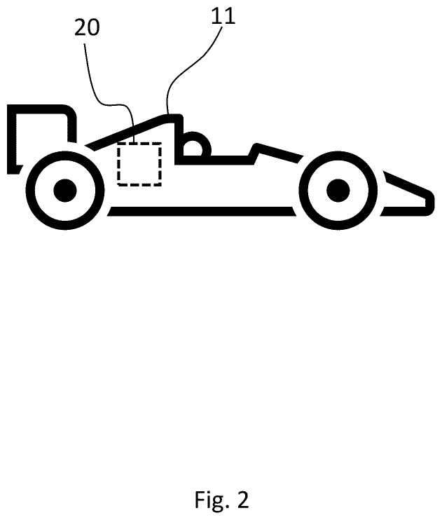

FIG. 2 illustrates schematically an example of a real-world racer car 11. The real-world racer car 11 comprises a racer data unit 20. The racer data unit 20 is configured to generate or measure telemetry data, and further transmit the telemetry data to an external computer system. The computer system may comprise one or more computing devices that are configured to perform tasks comprising computer instructions, as a combined unit. The computer system may be understood as a server, back-end, an edge computer system and/or a cloud-based computer system. The racer data unit 20 comprises the one or more sensors configured to detect the parameters of the real-world racer car 11 during the movement of the real-world racer car 11. It should be noted that the one or more sensors and other components of the racer data unit 20 may be distributed to different locations in the real-world racer car 11 or provided in a structurally compact unit.

As shown in FIG. 1, the real-world racetrack 10 is further provided with one or more environmental sensors 90, 91. The one or more environmental sensors 90, 91 are configured to generate or measure environmental measurement data of the real-world racetrack 10. The environmental sensors 90, 91 may comprise at least humidity sensor(s) configured to detect and/or measure humidity of the real-world racetrack 10 or rain sensor(s) configured to detect and/or measure rain in the real-world racetrack 10. In some exemplary embodiments, environmental sensors 90, 91 may comprise additionally, or instead of humidity and/or rain sensor(s), wind sensor(s) configured to detect or measure wind speed or speed and direction of the wind in the real-world racetrack 10, and/or temperature sensor(s) configured to measure temperature of the real-world racetrack 10 and/or temperature of the atmosphere in the real-world racetrack 10. In some exemplary embodiments, environmental sensors 90, 91 may comprise additionally, or instead of the above-mentioned sensors(s), one or more cameras configured to generate image data or video data from the real-world racetrack 10.

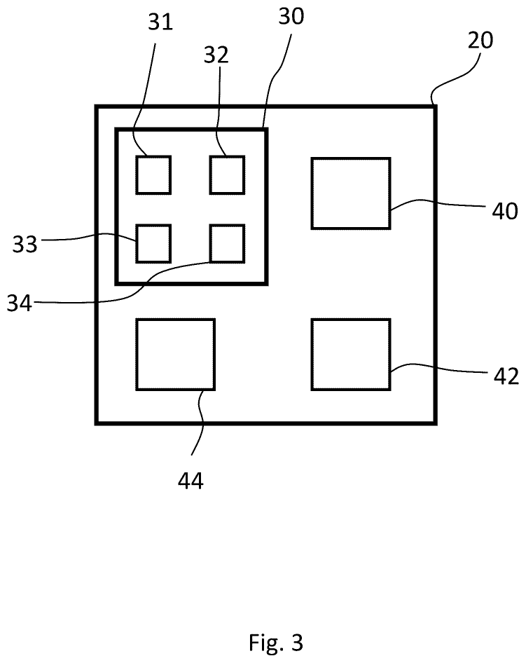

FIG. 3 illustrates schematically the racer data unit 20. The racer data unit 20 comprises a sensor module 30 comprising one or more sensors configured to detect and measure parameters of the real-world racer car 11, 12 and to generate telemetry data based on the detected parameters during the movement of the real-world racer car 11, 12 in or along the real-world racetrack 10. The sensor module 30 may comprise at least sensors for detecting position and motion of the real-world racer car 11, 12 in or along the real-world racetrack 10. Thus, the sensor module 30 is configured to generate position data and motion data of the real-world racer car 11, 12 during movement in the real-world racetrack 10. The sensor module 30 may comprise one or more position sensors 31 configured to detect position of the real-world racer car 11, 12 in or along the real-world racetrack 10. The position sensor 31 may be a navigation satellite receiver configured to detect or measure the position of the real-world racer car 11, 12, such as a GPS sensor (Global Positioning System sensor), or optical position sensor(s) configured to detect or measure the position of the real-world racer car 11, 12. It should be noted that the position sensor(s) 31 may be any kind of position sensor capable of detecting or measuring position of the real-world racer car 11, 12 in or along the real-world racetrack 10. The one or more position sensors are configured to continuously detect or measure the position of the real-world racer car 11, 12 in or along the real-world racetrack 10. The one or more position sensors are configured to continuously detect or measure instantaneous position of the real-world racer car 11, 12 in or along the real-world racetrack 10. The one or more position sensors 31 may be configured to continuously detect and/or measure instantaneous position of the real-world racer car 11, 12 in or along the real-world racetrack 10 with time intervals of 1 s or less. Accordingly, the one or more position sensors 31 are configured to detect or measure instantaneous position of the real-world racer car 11, 12 in or along the real-world racetrack 10 with output rate of at least 20 Hz (50 ms update rate), or with output rate of at least 60 Hz (16.7 ms update rate), or with output rate of at least 120 Hz (8.3 ms update rate), or with output rate of at least 200 Hz (5 ms update rate).

The one or more position sensors 31 are configured to generate position data. The telemetry data comprises the position data. The one or more position sensors 31 or the output thereof may be configured to measure or calculate speed of the real-world racer car 11, 12 in or along the real-world racetrack 10 based on the detected or measured position of the real-world racer car 11, 12 or based on the position data. Accordingly, the position data may be utilized for calculating speed of the real-world racer car 11, 12 in or along the real-world racetrack 10. The sensor module 30 may comprise one or more motion sensors 32 configured to detect motion of the real-world racer car 11, 12 in, or along, the real-world racetrack 10. The one or more motion sensors 32 are configured to detect at least speed of the real-world racer car 11, 12. Alternatively, the one or motion sensors 32 are configured to detect at least speed and acceleration of the real-world racer 11, 12. The one or more motion sensors 32 may comprise one or more of the following: accelerometer, gyroscope, position sensor, optical sensor, configured to detect or measure speed or speed and acceleration of the real-world racer car 11, 12. It should be noted that the motion sensor(s) 32 may be any kind of motion sensor capable of detecting or measuring speed and or speed and acceleration of the real-world racer car 11, 12 in or along the real-world racetrack 10. The one or more motion sensors 32 may be configured to continuously detect or measure the motion of the real-world racer car 11, 12 in or along the real-world racetrack 10. The one or more motion sensors 32 may be configured to continuously detect or measure instantaneous speed or speed and acceleration of the real-world racer car 11, 12 in or along the real-world racetrack 10.

The one or more motion sensors 32 may be configured to continuously detect or measure instantaneous speed or speed and acceleration of the real-world racer car 11, 12 in or along the real-world racetrack 10 with time intervals of 1 s or less. Accordingly, the one or more motion sensors 32 are configured to detect or measure instantaneous speed or speed and acceleration of the real-world racer car 11, 12 in or along the real-world racetrack 10 with output rate of at least 20 Hz (50 ms update rate), or with output rate of at least 60 Hz (16.7 ms update rate), or with output rate of at least 120 Hz (8.3 ms update rate), or with output rate of at least 200 Hz (5 ms update rate). The one or more motion sensors 32 may be configured to generate motion data. The telemetry data may comprise the motion data. The motion data may comprise speed data or speed data and acceleration data.

In some exemplary embodiments, the sensor module 30 may further comprise one or more orientation sensors 33 configured to detect or measure orientation or change of orientation of the real-world racer car 11, 12. Orientation of the real-world racer car 11, 12 may be understood to mean orientation of the real-world racer car 11, 12 in relation to the real-world racetrack 10. Alternatively, or additionally, the orientation of the real-world racer car 11, 12 may be understood to mean orientation of the real-world racer car 11, 12 in relation to the real-world racetrack 10 and in relation to compass points (or compass directions or north direction). The one or more orientation sensors 33 may comprise one or more of the following: accelerometer, gyroscope, optical orientation sensor, configured to detect or measure orientation or direction or orientation of the real-world racer car 11, 12. It should be noted that the orientation sensor(s) 33 may be any kind of orientation sensor capable of detecting or measuring orientation of the real-world racer car 11, 12 in or along the real-world racetrack 10. The one or more orientation sensors 33 may be configured to continuously detect or measure the orientation of the real-world racer car 11, 12 in or along the real-world racetrack 10. The one or more orientation sensors 33 may be configured to continuously detect or measure instantaneous orientation of the real-world racer car 11, 12 in or along the real-world racetrack 10.

The one or more orientation sensors 33 may be configured to continuously detect or measure instantaneous orientation of the real-world racer car 11, 12 in or along the real-world racetrack 10 with time intervals of 1 s or less. Accordingly, the one or more orientation sensors 33 are configured to detect or measure instantaneous orientation of the real-world racer car 11, 12 in, or along, the real-world racetrack 10 with output rate of at least 20 Hz (50 ms update rate), or with output rate of at least 60 Hz (16.7 ms update rate), or with output rate of at least 120 Hz (8.3 ms update rate), or with output rate of at least 200 Hz (5 ms update rate). The one or more orientation sensors 33 may be configured to generate orientation data. The telemetry data may comprise the orientation data. In some embodiments, the sensor module 30 may further comprise one or more instrumentation sensors 34 configured to detect or measure technical racer properties of the real-world racer car 11, 12 during movement in or along the real-world racetrack 10.

The one or more instrumentation sensors 34 may be configured to detect or measure any technical properties of the real-world racer car 11, 12 such as operation of racer technical systems and/or input of a human driver of the real-world racer car 11, 12 via racer input devices such as accelerator, brakes, and/or steering device. It should be noted that the instrumentation sensor(s) 34 may be any kind of instrumentation sensor capable of detecting or measuring technical properties of the real-world racer car 11, 12 in or along the real-world racetrack 10. The one or more instrumentation sensors 34 may be configured to continuously detect or measure the technical properties or instantaneous technical properties of the real-world racer car 11, 12 in, or along, the real-world racetrack 10. The one or more instrumentation sensors 34 may be configured to continuously detect or measure instantaneous technical properties of the real-world racer car 11, 12 in, or along, the real-world racetrack 10. The one or more instrumentation sensors 34 may be configured to continuously detect or measure instantaneous technical properties of the real-world racer 11, 12 in, or along, the real-world racetrack 10 with time intervals of 1 s or less. Accordingly, the one or more instrumentation sensors 34 may be configured to detect or measure instantaneous technical properties of the real-world racer car 11, 12 in, or along the real-world racetrack 10 with output rate of at least 20 Hz (50 ms update rate), or with output rate of at least 60 Hz (16.7 ms update rate), or with output rate of at least 120 Hz (8.3 ms update rate), or with output rate of at least 200 Hz (5 ms update rate).

The one or more instrumentation sensors 34 may be configured to generate instrumentation data. The telemetry data may comprise the instrumentation data. The real-world racer 11, 12 and the sensor module 30 thereof may also comprise additional sensors configured to generate additional measurement data. The telemetry data may comprise the additional measurement data.

The racer data unit 20 may further comprise a racer communication module 40 configured to provide communication connection with a computer system. The communication module 40 may be configured to transmit telemetry data from the real-world racer car 11, 12 to the external computer system. The racer data unit 20 may further comprise a memory 42 comprising instructions to operate the sensor module 30 and the sensors 31, 32, 33, 34, process the sensors measurement data and/or the telemetry data and operate the communication module 40 to transmit the telemetry data. The racer data unit 20 may also comprise one or more processors 44 for carrying out the instructions stored to the memory 42.

The communication module 42 may be any known communication module configured to carry out data transmission to the external computer system or data transfer between the external computer system and the racer data unit 20. The communication module may be for example one of the Internet communication module, mobile network communication module, a local area network (LAN) communication module, an ultra-wideband (UWB) or a wide area network (WAN) communication module or any other suitable communication module.

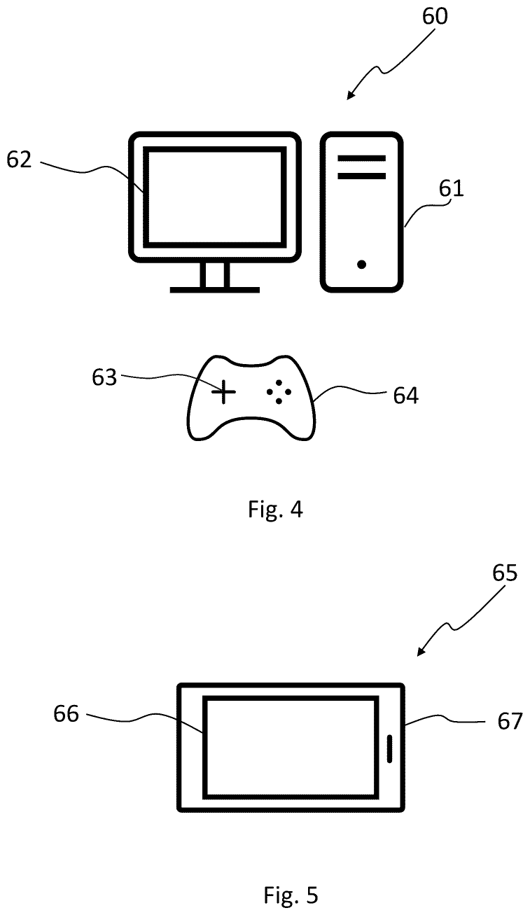

FIGS. 4 and 5 illustrate schematically examples of different user devices, such as a personal computer, laptop, mobile user device, game console, virtual reality device, or any other user device suitable for playing the racing game. It is to be noted that the user device may be connected to other devices as well such as headphones, head-mounted display, and so on. FIG. 4 illustrates an example of a user device that in this example is a game console 60. The user device 60 comprises a display device 62 and a user input device 64 having one or more user input elements 63. The user input device 64 is configured to generate control data as a response to user inputs. The user device 60 further comprises a display device 62 configured to present a virtual racing environment and/or a visual representation of the mixed-reality racing game according to the invention. It is to be noted that the display may comprise a head-mounted display that is comprised in, or connected to the user device. The user device 60 further comprises a central unit 61. The display device 62 is connected, with a wire or wirelessly, to the central unit 61 for receiving the visual representation from the central unit 61. The user input device 64 is connected, with a wire or wirelessly, to the central unit 61 and configured to provide the control data to the central unit 61. The central unit 61 may comprise at least a memory comprising instructions for operating the display device 62 and the user input device 64. The central unit 61 may further comprises at least one user device processor configured to carry out the instructions. The display device 62 may be any kind of display device, such as a computer display or television. The user input unit 64 may be any kind of user input device, such as a keyboard, a computer mouse, a game controller, or the like.

FIG. 5 illustrates another example of a user device 65, that in this example comprises an integrated display device 66. The user device 65 further comprises central unit 67 as integral part of the user device 65. The central unit 67 comprises at least a user device memory comprising instructions for operating the display device 66 and the user input device. The central unit 67 may further comprises at least one user device processor configured to carry out the instructions. The display device 66 is provided as a touchscreen configured to provide also the user input device. The display device 66 is configured to generate control data as a response to user inputs via the touchscreen. Alternatively, or additionally, the central unit 67 comprises one or more motion sensors configured to generate motion data based on the motion or orientation of the user device 65. The motion sensors may comprise one or more of the following: accelerometer, gyroscope and magnetometer, or any other motion sensors capable of detecting motion or orientation of the user device 65. Accordingly, the user device 65 itself, or the motion sensors thereof, form the user input device. The user device 65 is configured to generate control data as a response to moving of the user device 65 by the user. The user device 65 may be a mobile user device, such as a mobile phone.

The user devices 60, 65 or the central unit 61, 67 thereof may comprise a user device communication module for data transfer with an external computer system. The user device communication module may be any known communication module configured to carry out data transfer between the external computer system and the user device 60, 65. The user device communication module may be for example one of the Internet communication module, mobile network communication module, a local area network (LAN) communication module, or a wide area network (WAN) communication module, or a WiFi communication module, or a Bluetooth communication module, or an ultra-wideband (UWB) or any other suitable communication module. The present invention is not restricted to any type of user device communication module.

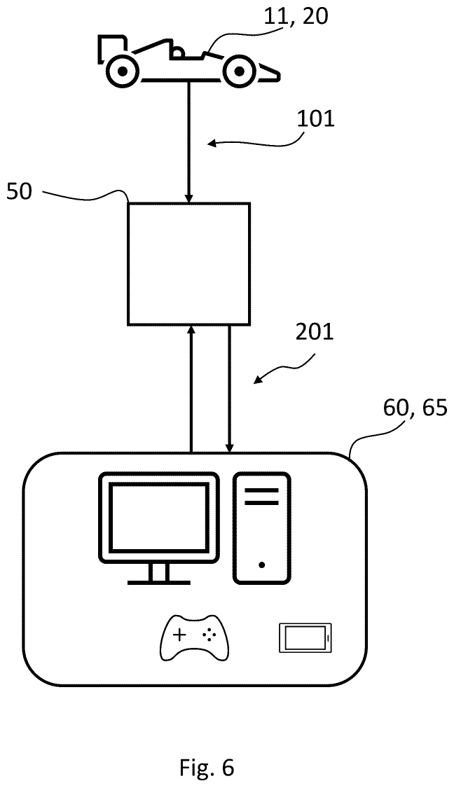

FIG. 6 illustrates an exemplary embodiment of the system. The system in this exemplary embodiment comprises a computer system 50. The computer system 50 may be configured to receive the telemetry data from the one or more real-world racer cars 11 or the racer data units 20 thereof over a first network connection 101. The computer system 50 is also configured to receive the control data from the user device 60, 65 over a second network connection 201. The first and second network connections 101, 201 may be, for example, any one of the Internet, mobile network, a local area network (LAN), or a wide area network (WAN), or an ultra-wideband (UWB), or some other communication network. In addition, the first and second network connections 101, 201 may be implemented by a combination thereof. The present invention is not restricted to any type of communication network or network connection.

The computer system 50 may be configured to generate a visual representation of a mixed-reality race game. The user device 60, 65 may be configured to receive the visual representation via the second network connection 201. The user device 60, 65 may further be configured to present the visual representation with the display device 62, 66. The computer system 50 comprises one or more processors and one or more memories. A software module is stored in the one or more memories. The software module comprises instructions to be carried out by the one or more processors of the computer system 50.

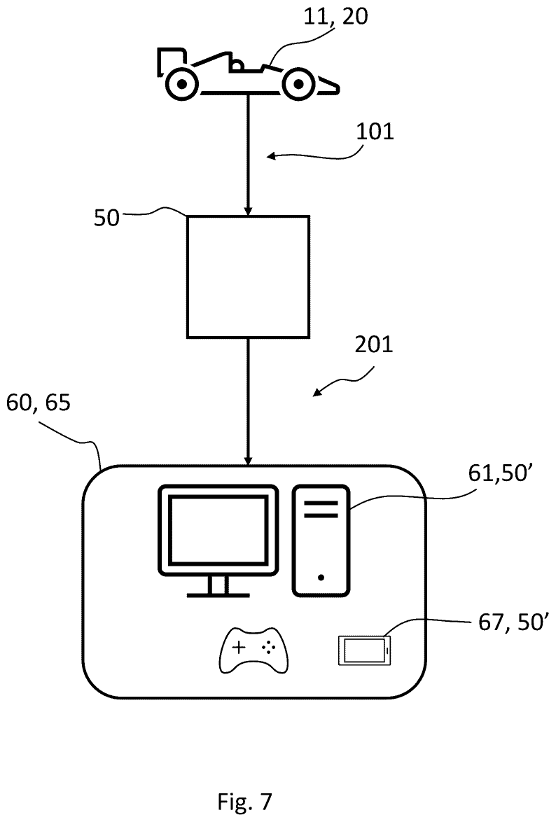

FIG. 7 illustrates another exemplary embodiment of the system. In this exemplary embodiment, the method and processing of tasks are distributed between the external computer 50 and the user device 60, 65. Accordingly, the computer system comprises the external computer system 50, as in FIG. 6, and the user device 60, 65, or the central unit 61, 67 thereof. The central unit 61, 67 may be configured to provide an internal computer system 50′. In the exemplary embodiment of FIG. 7, the external computer system 50 is configured to receive the telemetry data from the one or more real-world racer cars 11 or the racer data units 20 thereof over the first network connection 101. The user device 60, 65 or the central unit 61, 67, or the internal computer system 50′, is configured to receive the control data from the user device 60, 65 or from the user input device 64, 66 thereof. The external computer system 50 and the internal computer system 50′ may form together the computer system 50, 50′. The telemetry data may be further received in the user device 60, 65 via the second network connection 201 from the external computer system 50. Alternatively, the calculations based on the telemetry data may be carried out in the external computer system 50 and the calculation output may be received in the user device 60, 65 or the internal computer system 50′ for further processing.

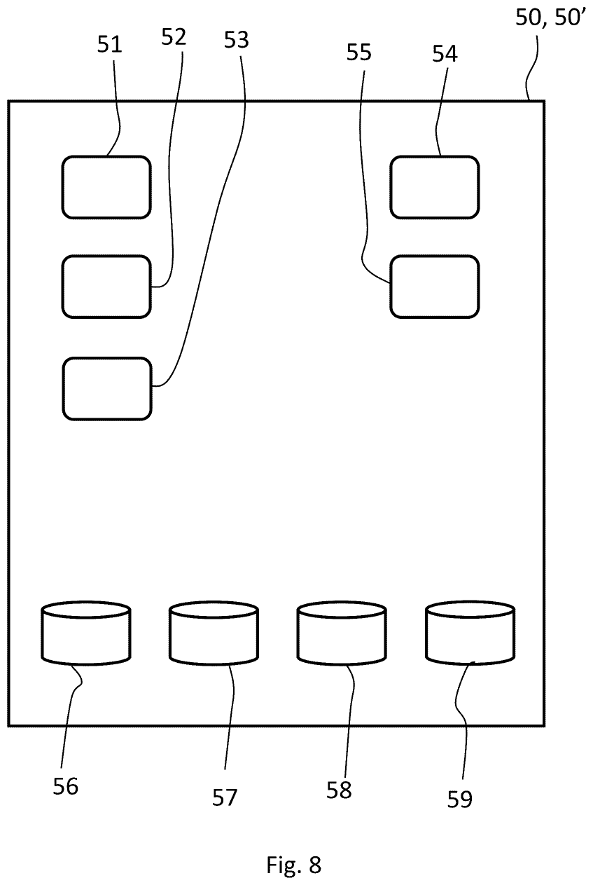

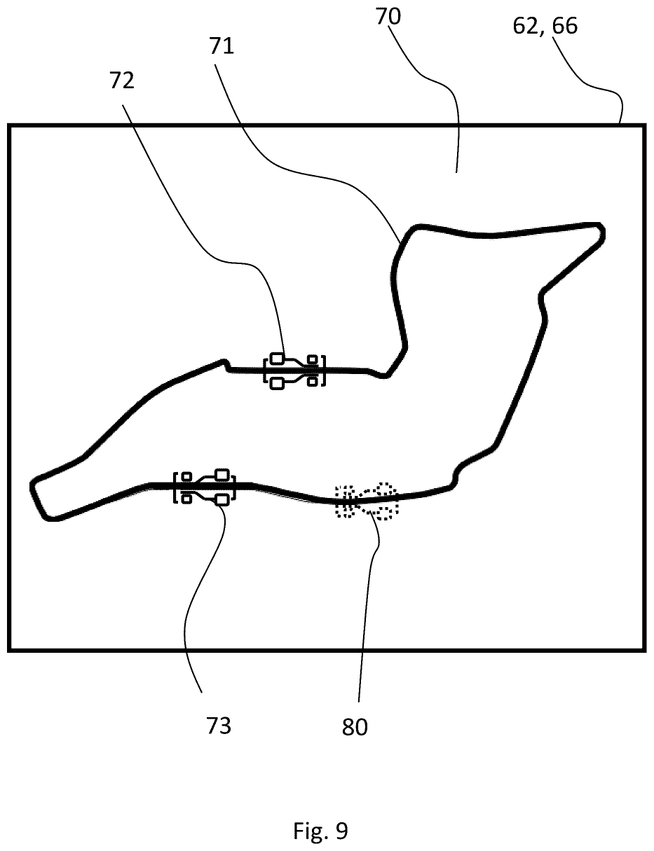

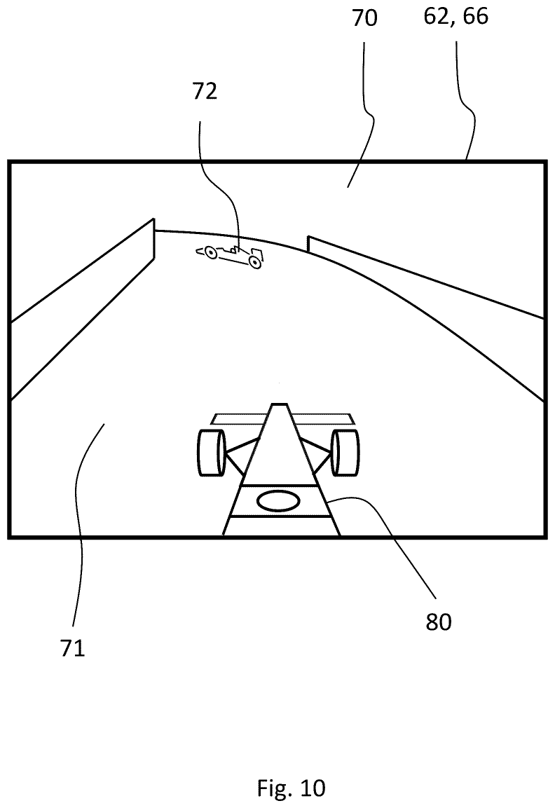

FIG. 8 illustrates a schematic configuration example of the software module which may operate the computer system 50, 50′. The computer system 50, 50′ may be configured to carry out the method steps of the present invention by utilizing the software module of the computer system 50, 50′. The computer system 50 and the software module thereof may comprise an input unit 51. The input unit 51 may be configured to receive the telemetry data and the control data. The input unit 51 may be configured to receive the telemetry data from the one or more real-world racers 11,12. The input unit 51 may be configured to receive the control data from the user device 60, 65. The computer system 50, 50′ and the software module thereof may comprise a real-world racer processing unit 53 configured to associate the telemetry data with a virtual racer car model 72, 73 and calculate position and speed of the virtual racer car model 72, 73 in a virtual racetrack 71 in a virtual racing environment 70 based on the telemetry data associated with the virtual racer car model 72, 73. The virtual racer car model 72, 73 may be configured to represent the real-world racer 11, 12, as shown in FIGS. 9 and 10.

The virtual racetrack 71 may configured to represent and correspond to the real-world racetrack 10 in the virtual racing environment 70. The virtual racetrack 71 may be a digital twin or digital representation or a digital replica of the real-world racetrack 10. The computer system 50, 50′ and the software module thereof may comprise a controllable virtual racer car processing unit 54 configured to provide a controllable virtual racer car 80, associating the control data with the controllable virtual racer 80 and calculate position and speed of the controllable virtual racer car 80 in the virtual racetrack 71 in the virtual racing environment 70 based on the control data associated with the virtual racer car model 72, 73.

The computer system 50, 50′ and the software module thereof may

comprise a virtualization unit 55 configured to provide the virtual racing environment 70 and the virtual racing track 71. The virtualization unit 55 may further be configured to generate the visual representation of the race game comprising the virtual racing environment 70 representing the virtual racer car model 72, 73 together the controllable virtual racer 80 in the virtual racetrack 71 based on the calculated position and speed of the virtual racer car model 72, 73 and the calculated position and speed of the controllable virtual racer car 80.

The computer system 50, 50′ and the software module thereof may comprise an output unit 52 configured to transmit visual representation as output data from the computer system 50, 50′. The output unit 52 may be configured to transmit the visual representation from the computer system 50, 50′ to the user device 60, 65. The computer system 50, 50′ and the software module thereof may comprise a virtual racer model database 56. The virtual racer model database 56 is configured to store one or more virtual racer car models 72, 73 configured to represent one or more real-world racer cars 11, 12. The computer system 50, 50′ and the software module thereof may comprise a telemetry database 57. The telemetry database 57 may be configured to store telemetry data received in the computer system 50, 50′. The computer system 50, 50′ and the software module thereof may comprise a virtual racetrack database 58. The virtual racetrack database 58 may be configured to store one or more virtual racetracks 71 or one or more virtual racing environments 70 comprising the virtual racetrack 71. The computer system 50, 50′ and the software module thereof may comprise a controllable virtual racer database 59. The controllable virtual racer database 59 is configured to store one or more controllable virtual racer cars 80.

FIG. 9 illustrates schematically an example of a 2-dimensional visual representation a mixed-reality race game comprising the virtual racing environment 70 representing the virtual racer car model 72, 73 together with the controllable virtual racer car 80 in the virtual racetrack 71 based on the calculated position and speed of the virtual racer car model 72, 73 and the calculated position and speed of the controllable virtual racer 80.

FIG. 10 illustrates schematically an example of a 3-dimensional visual representation a mixed-reality race game comprising the virtual racing environment 70 representing the virtual racer car model 72 together the controllable virtual racer car 80 in the virtual racetrack 71 based on the calculated position and speed of the virtual racer car model 72 and the calculated position and speed of the controllable virtual racer car 80. The 2-dimensional visual representation and the 3-dimensional visual representation may be configured to be presented by the display device 62, 66 of the user devices 60, 65.

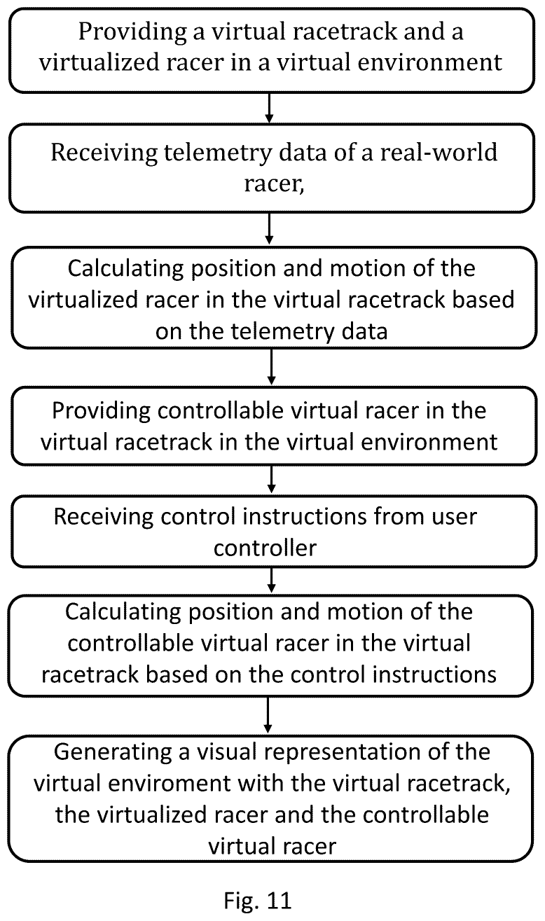

FIG. 11 illustrates a flow chart according to an exemplary embodiment in which mixed-reality race car game combines elements from the real-world to the mixed reality race game generated using software algorithms and in which a user may provide user input to a virtual representation of a real-world racer car, and the game then modifies the behaviour of the controllable virtual race car and/or the game in accordance with the received user input. For example, the virtualized real-world racetrack may be a racetrack in which a real-world car race event occurs, and the car race event is then broadcasted. The broadcasting may be used as an input based on which the mixed-reality race game is generated such that the virtual race car model corresponds to the real-world racer car participating in the car race event, the virtual racing environment corresponds to the environment of the car race event, the virtual racetrack is a representation of the real-world racetrack in which the racer cars participating are driving, and the user may have a user experience of participating in the race as well by providing input that controls the controllable virtual racer car in the mixed-reality game. This allows the user experience in which the user can feel as though being one of the drivers in the racer car event and competing against the real-world racer cars and their drivers.

The flow chart may be implemented using a computer-implemented method that in this exemplary embodiment comprises providing the virtual racing environment 70 comprising the virtual racetrack 71. The virtual racetrack 71 being a virtual representation of a real-world racetrack 10. The virtual racetrack 71 is provided from the virtual racetrack database 58. The method in this exemplary embodiment further comprises providing a virtual racer car model 72, 73 representing a real-world racer car 11, 12. The virtual racer car model 72, 73 being a virtual representation of a real-world racer car 11, 12. The virtual racer car model 72, 73 is provided from the virtual racer model database 56.

The method further comprises receiving telemetry data from the real-world racer car 11, 12. The telemetry data is associated with the virtual racer car model 72, 73. Each real-world racer 11, 12 provides individual telemetry data and the telemetry data of each of the real-world racer cars 11, 12 is associated with one virtual racer car model 72, 73 representing the real-world racer car 11, 12. The telemetry data may comprises a racer identifier and the telemetry data may be associated with the specific virtual racer car model 72, 73 based on the racer identifier. The virtual racer car model 72, 73 in the virtual racer model database 56 may comprise a corresponding model identifier and the telemetry data may be associated with the specific virtual racer car model 72, 73 based on the racer identifier and the model identifier.

The method further comprises calculating position data and motion data of the virtual racer car model 72, 73, or the virtualized racer, in the virtual racetrack 71 based on the telemetry data. Accordingly, the position and motion of the virtual racer car model 72, 73 in the virtual racetrack 71 is calculated to correspond the position and motion of the real-world racer car 11, 12 in the real-world racetrack 10. Therefore, the virtual racer car model 72, 73 in the virtual racetrack 71 becomes a virtualized racer car representing the movement of the real-world racer car 11, 12 in the real-world racetrack 10.

The telemetry data may be received as continuous telemetry data defining continuously at least the position and speed of the real-world racer car 11, 12 or continuously at least the instantaneous position and speed of the real-world racer car 11, 12 in the real-world racetrack 10. Accordingly, the method comprises calculating continuously instantaneous position and speed of the virtual racer car model 72, 73 in the virtual racetrack 71 based on the telemetry data. The telemetry data may be received as real-time telemetry and calculating continuously position and speed of the virtual racer model 72, 73 may be carried out continuously in real-time based on the received real-time telemetry data. Alternatively, the telemetry data may be stored to the telemetry database 57 and calculating continuously position and speed of the virtual racer car model 72, 73 may be carried out based on the telemetry data stored to the telemetry database 57.

The method also comprises providing the controllable virtual racer car 80. The virtual racer car 80 may be provided from the controllable virtual racer database 59. The virtual racer car 80 may be configured to be controllable by the user with the user device 60, 65 or the user input device 64, or controller, thereof. The method further comprises receiving control data from the user device 60, 65 and associating the control data with the controllable virtual racer 80. The method further comprises calculating position and speed of the controllable virtual racer car 80 in the virtual racetrack 71 based on the received control data associated with the controllable virtual racer car 80. The control data may be received as continuous control data defining continuously at least the position and speed of the controllable virtual racer car 80 or continuously at least the instantaneous position and speed of controllable virtual racer car 80 in the virtual racetrack 71. Accordingly, the method comprises calculating continuously instantaneous position and speed of the controllable virtual racer car 80 in the virtual racetrack 71 based on the control data.

The method further comprises generating a visual representation of the mixed-reality race game comprising the virtual racing environment 70 representing the virtual racer car model 72, 73 together with the controllable virtual racer car 80 in the virtual racetrack 71 based on the calculated position and speed of the virtual racer car model 72, 73 and the calculated position and speed of the controllable virtual racer car 80. Accordingly, generating the visual representation comprises generating visual representation comprising visual representation of the virtual racer car model 72, 73 in the virtual racetrack 71 based on the calculated position and speed of the virtual racer model 72, 73. Accordingly, the visual representation is configured to present the virtual racer car model 72, 73 in the virtual racetrack 71 with speed and position corresponding the real-world racer car 11, 12 in the real-world racetrack 10 with real-world speed and position. Further, generating the visual representation may comprise generating visual representation comprising visual representation of the controllable virtual racer car 80 in the virtual racetrack 71 based on the calculated position and speed of the controllable virtual racer car 80. Accordingly, the visual representation is configured to present the controllable virtual racer car 80 in the virtual racetrack 71 with speed and position calculated based on the control data. Accordingly, the visual representation may be configured to simultaneously represent the virtual racer car model 72, 73 and the controllable virtual racer car 80 in the virtual racetrack 71.

The method may also comprise continuously generating visual representation of the virtual environment 70 representing simultaneously instantaneous position and speed of the virtual racer car model 72, 73 and the controllable virtual racer car 80 in the virtual racetrack 71 based on the calculated position and speed of the virtual racer car model 72, 73 and the calculated position and speed of the controllable virtual racer car 80. The visual representation is continuously updated based continuously calculated instantaneous position and speed of the virtual racer car model 72, 73 and the calculated position and speed of the controllable virtual racer car 80.

It is to be noted that in at least some variations of the exemplary embodiment described above, there may be environmental sensors, such as described above, in the real-world environment that provide sensor information based on which the virtual racing environment may be generated for the mixed-reality race game, as well as the conditions of the virtualized racetrack, such that the environmental conditions generated for the mixed-reality race game correspond to those of the real-world when the car race event occurs. The environmental sensors may be used in addition to, or as an alternative to, software algorithms that may be used to detect from the broadcasting the weather conditions of the real-world environment and/or the real-world racetrack. Thus, the user may be enabled to experience the driving in conditions of the real-world, and the mixed-reality game may mimic the real-world environmental conditions based on input received from the environmental sensors and/or software algorithm(s) configured to detect the real-world environmental conditions from the broadcasting.

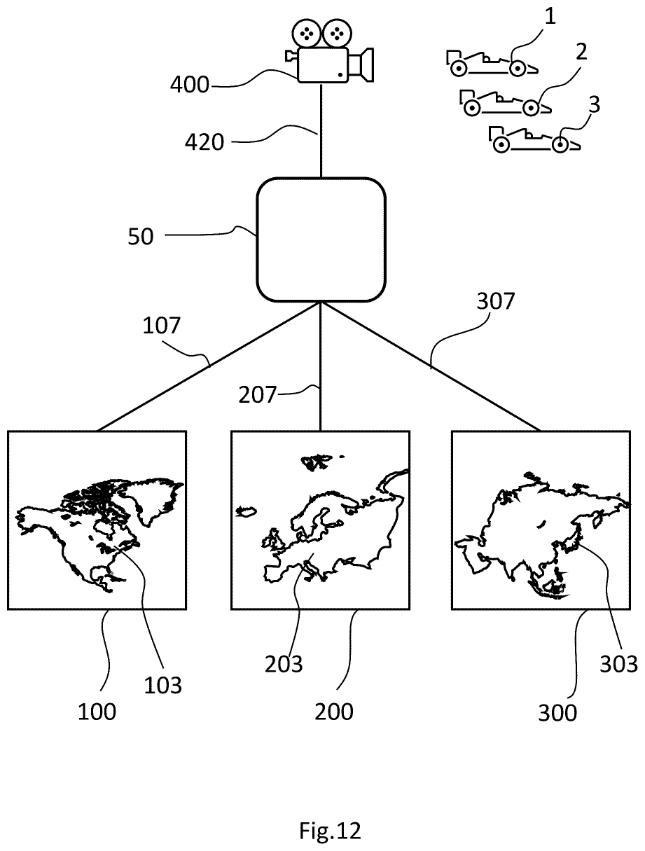

FIG. 12 illustrates schematically an exemplary embodiment of a system that may be utilized in providing an input video stream, that may be understood as the broadcasting, that may be used as a basis for generating the mixed-reality user experience discussed above. The system in this exemplary embodiment comprises at least one imaging device 400, such as a digital camera device, configured to generate the input video-stream of a car race event comprising one or more racer cars 1, 2, 3, which may also be understood as real-world racer cars such as the real-world racer cars 11, 20 discussed above. Therefore, the input video-stream in this exemplary embodiment comprises video images of the one or more racer cars 1, 2, 3. The car race event may be for example a formula race, such as Formula 1, IndyCar or Nascar race, or a rally race or any kind car race event. The imaging device 400 is configured to generate at least part of the input video-stream, or input video data, of the car race event. The system further comprises a computer system 50, such as described above. The computer system 50 in this exemplary embodiment is configured to receive the generated input video-stream over a first communication connection 42. The computer system 50 and the software module thereof comprises an input unit configured to receive the input video-stream. The input unit is further configured to receive a broadcast request from at least one user device. It is to be noted that the broadcast request may comprise user data that is discussed above. The input unit is further configured to receive two or more input video streams from two or more imaging devices 40. The computer system 50 and the software module thereof comprises an identification unit configured to identify the one or more race cars 1, 2, 3 in the input video-stream.

The computer system further comprises an identification unit that comprises an object detection algorithm trained to detect and identify the racer car 1, 2, 3 in the input video-stream. The input video-stream is utilized as input data into the object detection algorithm for detecting and identifying the racer car 1, 2, 3 in the input video-stream. In the context of this application, detecting the racer car 1, 2, 3 in the input video-stream may be understood to mean that existence of the race car 1, 2, 3 is detected in the input video-stream. In the context of the present invention identifying the racer car 1, 2, 3 in the input video-stream may be understood to mean that it is specifically identified which racer car 1, 2, 3 is detected in the input video-stream. It should be noted that each of racer cars 1, 2, 3 may be different in outer shape or in outer surface visual appearance. Therefore, there may be a need to identify the racer car 1, 2, 3, meaning which racer car or racer cars are present in the input video-stream.

The object detection algorithm may be configured to the identify the race cars 1, 2, 3 in the input video-stream. The object detection algorithm may be any known type of object detection algorithm such as a trained machine learning algorithm, neural network, statistical detection algorithm or the like. The object detection algorithm may be trained with images or videos or digital models of the race cars 1, 2, 3 for providing the trained objection detection algorithm. Optionally, the object detection algorithm is further configured to detect orientation of the detected racer car 1, 2, 3 in the input video-stream. The object detection algorithm may be trained to detect orientation of the racer car 1, 2, 3 in the input video-stream.

It should be noted that in some exemplary embodiments the object detection algorithm may be one algorithm configured to detect the racer car 1, 2, 3 in the input video stream, identify the detected racer car 1, 2, 3 and further detect the orientation of the identified racer car 1, 2, 3. Alternatively, the object detection algorithm may be provided as two, three or more different algorithms which together are configured to carry out together detect the racer car 1, 2, 3 in the input video stream, identify the detected racer car 1, 2, 3 and further detect the orientation of the identified racer car 1, 2, 3. Further, in some embodiments, the object detection algorithm may not be configured to detect the orientation of the race car 1, 2, 3 in the input image.

The computer system 50 and the software module thereof further comprises a content generation unit configured to generate a video item for the input video-stream. The content generation unit may be configured to generate the video item based on the identified race car 1, 2, 3 and geolocation information of the user device. The computer system 50 and the software module thereof further comprises a video processing unit configured to perform fitting of the generated video item on to the identified racer car 1, 2, 3 in the input video-stream to provide a manipulated video data, which may be provided as an output. Thus, the generated video item may be superimposed on the identified racer car 1, 2, 3. For example, fitting the generated video item on the identified race car in the input video-stream comprises providing a video item overlay or a video item layer on the input video stream for providing the manipulated video data. The computer system 50 and the software module thereof comprises an output unit that is configured to broadcast the manipulated video data as an output video-stream from the computer system 50 to the user device as a response to the broadcast request. The computer system 50 and the software module thereof further comprises a racer car database that comprises car profile data of each of the racer cars 1, 2, 3 of the car race event. Accordingly, each of the racer cars 1, 2, 3 of the car race event may be provided with a separate car profile data, or racer car profile, representing that specific racer car 1, 2, 3. The car profile data comprises information of the specific racer car.

The computer system 50 and the software module thereof also comprises a content database. The content database comprises video content elements, each video content element being associated with, or comprising, geolocation data defining a geographical area. It is to be noted that the video content element may also be referred to as video content, video element, video content item or video item. Each video content element may further be associated with car profile data of at least one race car 1, 2, 3. Accordingly, each video content element in the content database may be associated, or provided with, geolocation data or geolocation information and car profile data. Thus, the video content elements are race car specific and geographical area specific video content elements.

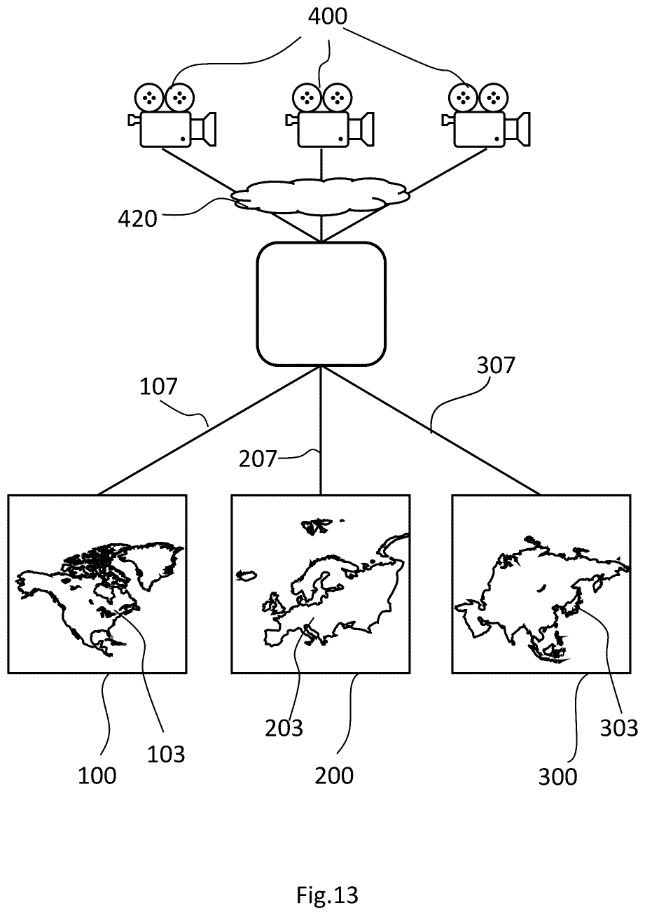

As shown in FIGS. 12 and 13, the input video-stream may be received in the input unit 51 of the computer system 50 via the first network connection 420. Further, separate broadcast requests for output video-stream of the car race event are received in the computer system 50 from user devices from different geographical locations 103, 203, 303 via second network connections 107, 207, 307, or communication network(s), respectively. In the exemplary embodiment of FIG. 12, there is one input video stream that is received in the computer system 50 via the first network connection 420 from the imaging device 400, and in the exemplary embodiment of FIG. 13, three input video streams are received in the computer system 50 via the first network connection 42 from imaging devices 400. Thus, there may be one or more input video streams received in the computer system 50 from one or more imaging devices 400.

The broadcast request may comprise a request to receive the output video-stream of the car race event in the user device. Each broadcast request may comprise user data, and the user data may comprise geolocation information of the user device. The geolocation information defines geographical location 103, 203, 303 of the user devices at the timepoint of transmitting the broadcast request. Accordingly, each received broadcast request may be associated with, or may comprise, the geographical location 103, 203, 303, of the user device. The geolocation information of the user device comprises for example an IP-address of the user device, communication network node data of the user device defining the network node to which the user device is connected, or navigation satellite system coordinates of the user device. In some exemplary embodiments, the geolocation information may also comprise some other information defining the geographical location 103, 203, 303 of the user devices. It should be noted that one or more broadcast requests may be received in the computer system 50. The computer system 50 may be configured to process each of the broadcast requests independently. In some exemplary embodiments, the computer system 50 may be configured to group received broadcast requests comprising corresponding, or same, geographical information defining corresponding, or same, geographical location of the user devices. The computer system may further be configured to process the grouped broadcast requests together or as one broadcast request.

The imaging device 400 and the computer system, 50 are, in this exemplary embodiment, connected or arranged in communication connection with the first communication connection or with the first communication network 420. Further, the computer system 50 and the user devices may be connected, or arranged, in communication connection with the second communication connections or with the second communication network(s) 107, 207, 307. It should be noted that the first and second communication connections or networks 420, 107, 207, 307 may be separate communication connections or networks or they may be parts of the same communication network. The communication network 420, 107, 207, 307, for example, may be any one of the Internet, mobile network, a local area network (LAN), or a wide area network (WAN), or an ultra-wideband (UWB), or some other communication network. In addition, the communication network 42, 101, 201, 301 may be implemented by a combination thereof. The present invention is not restricted to any type of communication network. In some exemplary embodiments, the first and second communication connections or networks 420, 107, 207, 307 may be arranged to be parts of a combined communication network. Accordingly, the computer system 50 may comprise a system communication element configured to receive the input video-stream(s) and the broadcast request(s), as well as broadcast the output video-stream. Thus, the system communication element may be configured to provide connection to the first communication network 420 and to the second communication network 107, 207, 307.

Further, the imaging device 400, or an imaging system comprising the imaging device 400, may comprise an imaging device communication element configured to transmit or send the input video-stream to the computer system 50. Thus, the imaging device communication element may be configured to provide connection to the first communication network 420. The user device may comprise a user device communication element configured to transmit the broadcast request to the computer system 50 and to receive the output video-stream from the computer system 50. Thus, the user device communication element may be configured to provide connection to the second communication network 107, 207, 307.

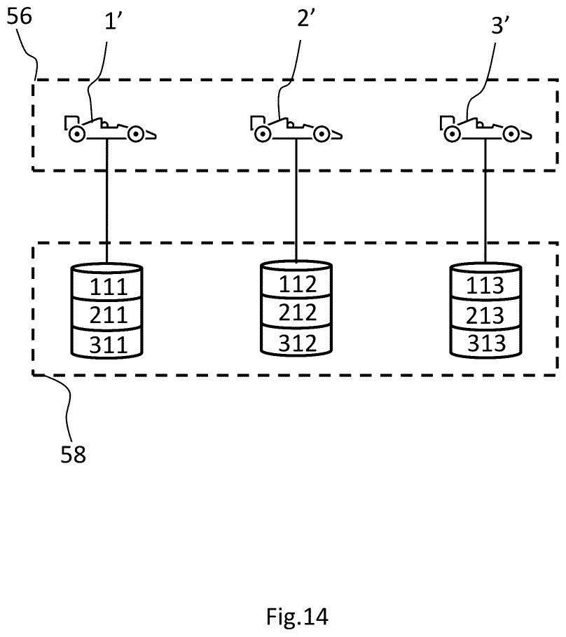

FIG. 14 illustrates schematically an exemplary embodiment of a database structure. The database structure in this exemplary embodiment comprises the racer car database 56 comprising separate car profile data 1′, 2′, 3′ for each of the race cars 1, 2, 3 of the car race event. The racer car profile data 1′, 2′, 3′ comprises car information of the specific race car 1, 2, 3, respectively. The database in this exemplary embodiment also comprises a content database, which comprises one or more specific video content elements 111, 112, 113, 211, 212, 213, 311, 312, 313 that may be associated, which may also be understood as being or linked or connected to, each of the specific car profile data 1′, 2′, 3′, respectively, as shown in FIG. 5. Each specific video content element 111, 112, 113, 211, 212, 213, 311, 312, 313 associated to the specific car profile data 1′, 2′, 3′ may be associated with different geolocation data. Associating with may also be understood as being connected with. The geolocation data in this exemplary embodiment defines a specific geographical area 100, 200, 300. Accordingly, each specific video content element 111, 112, 113, 211, 212, 213, 311, 312, 313 may be associated to a specific geographical area 100, 200, 300. For example, each specific video content element 111, 112, 113, 211, 212, 213, 311, 312, 313 which is associated to a specific car profile data 1′, 2′, 3′, may be associated to a different geographical area 100, 200, 300. Therefore, each car profile date 1, 2′, 3′, and thus identified race car 1, 2, 3, may be provided with one or more geographically targeted or limited to video content elements 111, 112, 113, 211, 212, 213, 311, 312, 313.

For example, in FIG. 14 the first car profile data 1′ may be associated with first video content elements 111, 112, 113. Each of the first video content elements 111, 112, 113 may be associated with different first geolocation data, and each different first geolocation data may be configured to define a different first geographical area 100, 200, 300. Similarly, the second car profile data 2′ may be associated with second video content elements 211, 212, 213, each of the second video content elements 211, 212, 213 being associated with different second geolocation data, and each different second geolocation data may be configured to define a different second geographical area 100, 200, 300. Further, the third car profile data 3′ may be associated with third video content elements 311, 312, 313. Each of the third video content elements 311, 312, 313 may be associated with different third geolocation data, each different third geolocation data being configured to define a different third geographical area 100, 200, 300.

The geographical area 100, 200, 300 of the geolocation data may be any defined geographical area, such as a continent, a country, a city, a part of continent, country or city, any other geographical area. In the exemplary embodiments of the figures, the first geographical area 100 is North America, the second geographical area 200 is Europe and the third geographical area 300 is Asia. The computer system 50 may be configured to receive the broadcast requests from the user devices located at different geographical locations 103, 203, 303. The broadcast requests may comprise the user data. The user data may comprise the geolocation information of the user device and the geolocation information is configured to define the geographical location 103, 203, 303 of the user devices. For example, the first user device 102 may comprise a first geolocation information in the broadcast request. The first geolocation information may be configured to define a first geographical location 103 of the first user device. The first geographical location is within the first geographical area 100. The second user device may comprise a second geolocation information in the broadcast request. The second geolocation information may be configured to define a second geographical location 203 of the second user device. The second geographical location is within the second geographical area 200. Further, the third user device may comprise a third geolocation information in the broadcast request. The third geolocation information may be configured to define a third geographical location of the third user device. The third geographical location is within the third the third geographical area 300.

In this exemplary embodiment, in the content database, each of the first video content elements 111, 112, 113, associated with the first car profile data 1′, are each associated with different geolocation data and further to a different geographical area 100, 200, 300. The first video content element 111 is associated with the geolocation data configured to define the first geographical area 100. The first video content element 112 is associated with the geolocation data configured to define the second geographical area 200. Further, the first video content element 113 is associated with the geolocation data configured to define or represent the third geographical area 300. Similarly, in the content database, each the second video content elements 211, 212, 213, associated with the second car profile data 2′, are each associated with a different geolocation data and further with a different geographical area 100, 200, 300. The second video content element 211 is associated with the geolocation data configured to define the first geographical area 100. The second video content element 212 is associated with the geolocation data configured to define the second geographical area 200. Further, the second video content element 213 is associated with the geolocation data configured to define the third geographical area 300. Further, in the content database, each the third video content elements 311, 312, 313, that are associated with the third car profile data 3′, are each associated with a different geolocation data and further with a different geographical area 100, 200, 300. The third video content element 311 is associated with the geolocation data configured to define or represent the first geographical area 100. The third video content element 312 is associated with the geolocation data configured to define the second geographical area 200. Further, the third video content element 313 is associated with the geolocation data configured to define the third geographical area 300.

Upon receiving the input video-stream from the imaging device 40 via the input unit 51 of the computer system 50, the input video-stream may be provided to the identification unit 53 as an input. The identification unit 53 is configured to detect and identify the specific race car 1, 2, 3 in the input video-stream. As a response to the detecting and identifying the specific race car 1, 2, 3 in the input video-stream the computer system 50 is configured to associate or connect or link the identified race car 1, 2, 3 to the specific car profile data 1′, 2′, 3′ corresponding the identified race car 1, 2, 3. It is to be noted that the input-video stream may also be used as an input to provide the virtual race track and the virtualized racer in the virtual environment for the mixed-reality race game discussed previously. In such a use case, the racetrack of the real-life race is then represented as the virtual racetrack and the virtual environment may be generated to correspond to the environment of the car race event.

Associating the identified race car 1, 2, 3 with the specific car profile data 1′, 2′, 3′ corresponding the identified race car 1, 2, 3 may be carried out for example based on the identification output of the identification unit 53 and the car profile data 1′, 2′, 3′, or based on the output of the object detection algorithm and the car profile data 1′, 2′, 3′. The computer system 50 may be configured to receive the broadcast request from the one or more user devices. Each broadcast request may be provided with the user data comprising geolocation information of the user device. The geolocation information defining the geographical location 103, 203, 303 of the user devices.

The racer car 1, 2, 3 may be detected and identified by the identification unit 53 of the computer system 50.

In the following it may be defined that the detected and identified racer car is the second race car 2. However, it should be noted that the identification unit 53 may also detect and identify two or more race cars 1, 2, 3 at the same time, or any of the race cars 1, 2, 3 of the car race event. The identified racer car may then be virtualized such that it may be provided as the virtualized racer car in the mixed-reality race game. The second racer car may thus be configured to provide telemetry data allowing it to be included in the mixed-reality race game.

The identified second race car 2 may be associated with the second car profile data 2′ based on the identifying the second race car 2 and the second car profile data 2′. The computer system 50 may then be configured to generate different output video-stream for different geographical areas 100, 200, 300 based on the broadcast requests and the geolocation information of the broadcast requests. For example, first the computer system 50 and the content generation unit 54 thereof may be configured to selecta a second video content element 211, 212, 213 which is associated with the second car profile data 2′ of the identified second race car 2. The video content generation unit 54 may then be further configured to select the second video content element 211, 212, 213 which is associated with geolocation data defining the geographical area 100, 200, 300 within which the geographical location of the user device is determined to be based on the broadcast request.

Accordingly, the content generation unit 54 may be configured to select the video item 211 for the first broadcast request from the first user device based on the geographical location 103 of the first user device being within the first geographical area 100. Similarly, the content generation unit 54 may be configured to select the video item 212 for the second broadcast request from the second user device based on that the geographical location 203 of the second user device being within the second geographical area 200. Further, the content generation unit 54 may be configured to select the video item 213 for the third broadcast request from the third user device based on that the geographical location 303 of the third user device being within the third geographical area 200. It is to be noted that when selecting the video item 211, 212 and/or 213, the video item may be modified, using one or more suitable software algorithm(s), such that the appearance of the selected video item 211, 212, and/or 213 matches the environmental conditions of the environment in which the car race event occurs. For example, the appearance may reflect rainy conditions or sunny conditions in accordance with the weather and/or lighting conditions of the environment of the car race event.

Then the computer system 50 and the video processing unit 55 thereof may be configured to fit the generated video item 211 on the identified second race car 2 in the input-video stream to provide a first manipulated video data. The computer system 50 and the output unit 52 thereof is further configured broadcast the first manipulated video data as a first output video-stream from the computer system 50 to the first user device as response to the first broadcast request. Thus, the first user device may be used to play the mixed-reality race game such that the game comprises the first manipulated video data.

Similarly, the computer system 50 and the video processing unit 55 thereof may be configured to fit the generated video item 212 on the identified second race car 2 in the input-video stream to provide a second manipulated video data. The computer system 50 and the output unit 52 thereof is further configured broadcast the second manipulated video data as a second output video-stream from the computer system 50 to the second user device as response to the second broadcast request. Thus, the first user device may be used to play the mixed-reality race game such that the game comprises the second manipulated video data.

Further, the computer system 50 and the video processing unit 55 thereof may be configured to fit the generated video item 213 on the identified second race car 2 in the input-video stream to provide a third manipulated video data. The computer system 50 and the output unit 52 thereof is further configured broadcast the third manipulated video data as a third output video-stream from the computer system 50 to the third user device as response to the third broadcast request. Thus, the first user device may be used to play the mixed-reality race game such that the game comprises the first manipulated video data.

Fitting the generated video item on the detected and identified race car may be carried out with a fitting algorithm which is configured to fit the generated video item on the race car based on the detection of the race car in the input video-stream, or based on the output of the identification unit 53, or based on the output of the object detection algorithm. In some exemplary embodiments, the identification unit 53, or the object detection algorithm thereof, is configured to detect the border lines or surfaces of the race car in the input video-stream. Fitting the generated video item on the detected and identified race car is then carried out with a fitting algorithm which is configured to fit the generated video item on the identified racer car based on the detected border lines or surfaces of the racer car by the identification unit 53 or the object detection algorithm.

In some exemplary embodiments, fitting the generated video item on the detected and identified race car by the computer system 50 comprises providing a video item layer comprising the generated video item, and combining the video item layer and the input video-stream for fitting the generated video item on the race car such that the manipulated video data is provided. In some exemplary embodiments, fitting the generated video item on the detected and identified race car by the computer system comprises splitting the input video-stream into a race car layer and a background layer, the race car layer comprising the detected racer car and the background layer comprising image data outside the detected racer car. The fitting further comprises fitting the generated video item on the detected racer car in the racer car layer and combining the background layer and the race car layer to provide the manipulated video data.

In some exemplary embodiments, fitting the generated video item on the detected and identified racer car by the computer system comprises splitting the input video-stream into a first race car layer, a second race car layer and a background layer. The first race car layer comprises the first detected race car, the second race car layer comprises the second detected race car and the background layer comprises image data outside the detected first and second race cars. The fitting further comprises fitting the first generated video item on the first detected race car in the first race car layer, fitting the second generated video item on the second detected race car in the second race car layer, and combining the background layer, the first race car layer and the second race car layer to provide the manipulated video data.

The orientation of the racer car may vary in the input video-stream. Accordingly, the racer car may be detected from different or varying viewing angles in the input video-stream as the racer cars 1, 2, 3 move often in relation to the imaging device 40. Therefore, it is beneficial that the orientation of the racer car in the video-stream is detected such that the generated video item may be fitted on to the identified race car in an appropriate orientation. In the context of this application the orientation of the racer car may be understood as a viewing angle of the race car 1, 2, 3 in the input video-stream. Accordingly, the computer system 50 and the identification unit 53 or the content generation unit 54 thereof may be configured to detect the orientation of the racer car 1, 2, 3 in the input video stream.

In some exemplary embodiments, identifying the racer car 1, 2, 3 in the input video-stream in the identification unit 53 may comprise detecting the orientation of the racer car 1, 2, 3 in the input video stream. Thus, identifying the race car 1, 2, 3 in the input video-stream in the identification unit 53 may comprise providing the detection algorithm trained to detect orientation of the race car in the input video-stream, and utilizing the input video-stream as input data into the object detection algorithm for detecting the orientation the race car in the input video-stream. Detecting the orientation may be carried out with same or separate object detection algorithm as detecting the race car in the input video-stream and/or identifying the race car 1, 2, 3 in the input video-stream. Alternatively, the identification unit 53 may comprise a separate object orientation detection algorithm. In some other exemplary embodiments, generating the video item in the content generation unit 54 comprises detecting the orientation of the race car 1, 2, 3 in the input video stream.

Thus, generating the video item in the content generation unit 54 may comprise providing the orientation detection algorithm trained to detect orientation of the racer car in the input video-stream, and utilizing the input video-stream as input data into the orientation detection algorithm for detecting the orientation of the racer car in the input video-stream. Then, the generated video item may then be oriented according to the orientation of the race car. Accordingly, generating the video item in the content generation unit 54 may comprise calculating orientation for the generated video item based on the detected orientation of the identified racer car and generating an oriented video item based on the calculation.

In some exemplary embodiments, generating the video item in the content generation unit 54 comprises calculating orientation for the generated video item based on an output of the object detection algorithm or orientation detection algorithm and generating the oriented video item based on the calculation. Accordingly, the detected orientation of the racer car may be utilized for calculating the orientation of the video item for providing the oriented video item. The orientation of the oriented video item may then be configured to correspond the orientation of the race car in the input video stream, and to be fitted on the identified racer car in the input-video stream to provide the manipulated video data. Therefore, the video item may be fitted in the same orientation as the racer car 1, 2, 3 is detected.

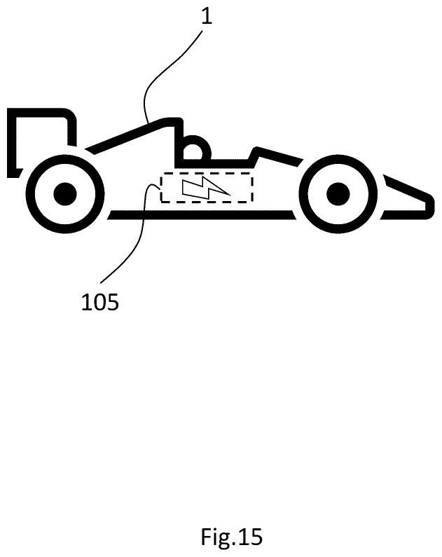

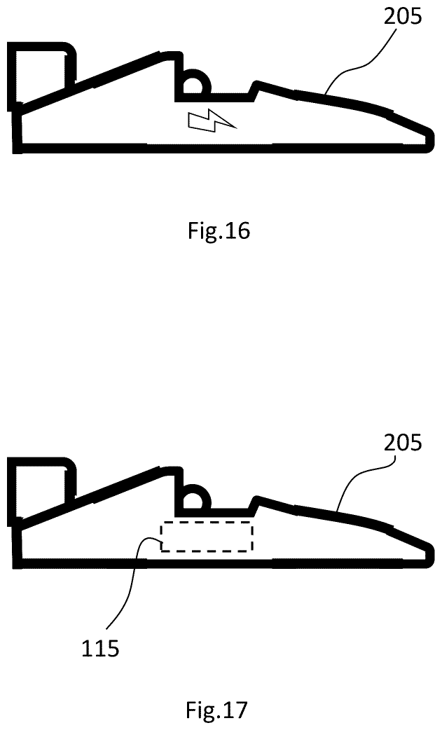

The video item may be a separate video item 105 which is configured to be fitted on a part of the racer car 1, 2, 3 or outer surface thereof, as shown in FIG. 15. FIG. 16 illustrates an exemplary embodiment in which the video item 205 is a three-dimensional image element configured to correspond the shape of the race car or part of the shape of the race car. Thus, the video item 205 may be configured to form part of the outer surface of the race car 1, 2, 3 in the output video-stream. Accordingly, the video item 205 may be a three-dimensional car model representing the race car, as shown in FIG. 16. Accordingly, there may two or more three-dimensional car models 205 as the video items with different geolocation information.

FIG. 17 illustrates a further exemplary embodiment, in which the racer car database 56 and the car profile data comprises the three-dimensional car model 205 representing the race car. The content database further comprises separate video items. The three-dimensional car model 205 is provide with an associated video item portion 115 as shown in FIG. 17. In some embodiments, the identifying in the identification unit 53 comprises comparing the race car in the input video-stream to the three-dimensional car model 205 for identifying the race car in the input video-stream. Accordingly, the three-dimensional car model may be utilized in identifying the race car.

In some further exemplary embodiments, detecting the orientation of the identified racer car in the input video-stream comprises determining the orientation of the racer car based on the detected racer car in the input video stream and the three-dimensional model 205 of the racer car of the identified racer car. Accordingly, the orientation of the three-dimensional model 205 may be adjusted such that the orientation the three-dimensional model 205 corresponds to the orientation of the racer car in the input video-stream. Thus, the three-dimensional model 205 may be fitted on the racer car 1, 2, 3 in the input video-stream by adjusting the orientation the three-dimensional model 205 to correspond the orientation of the race car 1, 2, 3 in the input video-stream. Therefore, the three-dimensional car model may be utilized for efficiently determining the orientation of the race car in the input video.

In some exemplary embodiments, the orientation of the generated video item may be calculated based on the determined three-dimensional car model 205, and the three-dimensional model 205 may be fitted on the racer car in the input video-stream for providing the manipulated video data. Alternatively, the video item 105 may be fitted on the three-dimensional model 205. The video item 105 may be fitted for example on the three-dimensional model 205 and on the associated video item portion 115 of the three-dimensional model 205. The orientation of the race car in the input video may be determined by fitting three-dimensional car model to the identified racer car, and thus the orientation of the fitted three-dimensional car model may represent the orientation of the racer car in the input video.

The manipulated video data as output video-stream may be broadcasted by the computer system 50 via the output unit 52 to the user device based on the broadcast request. The computer system may additionally use the manipulated video data to generate the mixed-reality content comprising the virtual racing environment that corresponds to the racing environment of the captured input video stream and the virtual racetrack that represents the real-world racetrack captured in the input video stream. At least one racer car comprising the generated video item, that is generated based on the location data of the broadcast request received from the user device. The user device may then also be utilized by the user to provide the control data for the controllable virtual racer car model that is then provided in the mixed-reality race game.

The user device may then be configured to receive the broadcasted output video-stream. The user device may further be configured to display the output video-stream as part of the mixed-reality game on a display of the user device in the defined geographical location 103, 203, 303 of the user device 102, 202, 302, respectively. Accordingly, the generated output video with the video item is displayed in the geographical location of the user device, and the video item is specific to the geographical location of the user device.

It is to be noted that the exemplary embodiments discussed above are combinable together, and that the units discussed may be understood as logical units the implementation of which may vary. The exemplary embodiments discussed above may be used to provide the user experience in which the user may interact with a mixed-reality game that represents a real-world race game, and the user may participate in the game using user input to provide control data for a controllable virtual racer car. This also allows the user to experience a multi-player game without necessarily having other players present at the moment of playing. Additionally, at least one of the real-world racer cars may be represented in the mixed-reality game such that their visual appearance is customized for the geographical location of the user device. This allows targeted messaging for example to the geographical location of the user device and/or for the user of the user device. The targeted messaging may be used for example to ensure that the visual content is appropriate for that geographical location and/or that user.

1. A computer-implemented method for a mixed-reality race game, the method comprising:
providing, by at least one computer processor, a virtual racing environments comprising a virtual racetrack, the virtual racetrack being a virtual representation of a real-world racetrack;
providing, by the at least one computer processor, a virtual racer car model representing a real-world racer car;
providing, by the at least one computer processor, a controllable virtual racer car;
receiving, by the at least one computer processor, telemetry data from at least one sensor associated with the real-world racer car moving on the real-world racetrack, the telemetry data comprising at least position data and motion data of the real-world racer car;
calculating, by the at least one computer processor, virtual coordinates configured to represent a position in the virtual racetrack based at least in part on the telemetry data of the real-world racer car to associate the telemetry data of the real-world racer car with the virtual racer car model;
receiving, by the at least one computer processor, from a user device, control data associated with the controllable virtual racer car, and user data comprising geolocation information of the user device the geolocation information defining geographical location of the user device;
obtaining, by the at least one computer processor, a video item associated with the geolocation information and profile of the real-world racer car;
fitting, by the at least one computer processor, the video item on the virtual racer car model representing the real-world racer car to fit the video item on the virtual racer car model for the geographical location of the user device;
calculating, by the at least one computer processor, a position and a speed of the virtual racer car model in the virtual coordinates of the virtual racetrack based on the telemetry data;
calculating, by the at least one computer processor, a position and a speed of the controllable virtual racer car in the virtual coordinates of the virtual racetrack based on the control data;
generating, by the at least one computer processor, in a display device associated with the user device, a visual representation of the mixed-reality race game comprising the virtual racing environment together with the controllable virtual racer car in the virtual racetrack, wherein the visual representation is generated at least partly based on the position and the speed of the virtual racer car model and the position and the speed of the controllable virtual racer car in the virtual coordinates.

2. A method according to claim 1, wherein:
the virtual racetrack comprises positioning data configured to define positions in the virtual racetrack, the positioning data comprising real-world coordinates configured to associate corresponding positions in the real-world racetrack with the defined positions in the virtual racetrack; or
the virtual racetrack comprises positioning data defining positions in the virtual racetrack, the positioning data comprises virtual coordinates configured to represent positions in the virtual racetrack and real-world coordinates configured to represent positions in the real-world racetrack, the positioning data being configured to associate virtual coordinates with corresponding real-world racetrack,
the virtual racetrack comprises positioning data comprising spatial mapping data configured to define positions of the virtual racetrack and corresponding real-world positions in the real-world racetrack.

3. A method according to claim 1, wherein the real-world racer car comprises one or more sensors configured to detect parameters of the real-world racer and to generate the telemetry data based on the detected parameters, and wherein the detected parameters comprise at least position and motion of the real-world racer car detected by the one or more sensors.

4. A method according to claim 1, further comprising:
receiving, by the at least one computer processor, the telemetry data as continuous telemetry data from the real-world racer car; or
receiving, by the at least one computer processor, the telemetry data as streaming telemetry data from the real-world racer car; or
receiving, by the at least one computer processor, the telemetry data as continuous streaming telemetry data from the real-world racer car.

5. A method according to claim 1, further comprising receiving, by the at least one computer processor, the control data as continuous control data.

6. A method according to claim 1, wherein the control data comprises at least motion control data, the motion control data defining motion of the controllable virtual racer car in the virtual racing environment.

7. A method according to claim 1, wherein the telemetry data is received as real-time telemetry data, and the method further comprises calculating continuously real-time position and speed of the virtual racer car model in the virtual racetrack based on the real-time telemetry data.

8. A method according to claim 1, further comprising continuously generating, by the at least one computer processor, a visual representation of the virtual environment representing, concurrently, instantaneous position and speed of the virtual racer car model and the controllable virtual racer car in the virtual racetrack based on the position and the speed of the virtual racer car model and the position and the speed of the controllable virtual racer car.

9. A method according to claim 1, further comprising:
receiving, by the at least one computer processor, environmental measurement data from one or more environmental sensors provided in connection with the real-world racetrack;
calculating, by the at least one computer processor, racetrack data by utilizing the environmental measurement data; and
determining, by the at least one computer processor, virtual racing environment characteristics of the virtual racing environment or virtual racetrack characteristics of the virtual racetrack based on the calculated racetrack data.

10. A method according to claim 1, further comprising:
receiving, by the at least one computer processor, an input video-stream of a car race event occurring in the real-world racetrack, the input video-stream comprising the real-world race car, and wherein the virtual racing environment is provided based on, at least partly, the received input video-stream; and
receiving, by the at least one computer processor, from the user device, a broadcast request for output video-stream of the car race event, wherein the request comprises the user data.

11. A method according to claim 10, further comprising:
identifying, by the at least one computer processor, the real-world racer car in the input video-stream, the identifying comprising defining profile data of the real-world race car;
determining, by the at least one computer processor, that the defined profile data corresponds to a profile data representing the real-world race car that is stored in a race-car database; and
broadcasting, by the at least one computer processor, as a response to the request, the output video-stream comprising the virtual racer car model with the fitted video item, the virtual racer car model representing the real-world racer car.

12. A method according to claim 10, further comprising:
detecting, by the at least one computer processor, an orientation of the real-world race car in the input video-stream;
calculating, by the at least one computer processor, an orientation for the generated video item based on the orientation of the real-world race car;
generating, by the at least one computer processor, an oriented video item by applying the orientation to the video item; and
fitting, by the at least one computer processor, the oriented video item in the input video-stream to provide the output video-stream.

13. A method according to claim 1, further comprising one or more of the following:
providing, by the at least one computer processor, the video item as a unique non-fungible token; or
linking, by the at least one computer processor, the video item to a unique non-fungible token; or
storing, by the at least one computer processor, the video item with a unique non-fungible token in a blockchain.

14. A method according to claim 1, further comprising one or more of the following:
providing, by at least one computer processor, a plurality of virtual racing environments comprising the virtual racing environment, and comprising a plurality of virtual racetracks, the plurality of virtual racetrack being a plurality of virtual representations of the real-world racetrack;
providing, by the at least one computer processor, a plurality of virtual racer car models representing a real-world racer car, the plurality of virtual racer car model comprising the virtual race car model;
providing, by the at least one computer processor, a plurality of controllable virtual racer cars associated with a plurality of user devices, the plurality of controllable virtual racer cars comprising the controllable virtual racer car, and the plurality of user devices comprising the user device;
fitting, by the at least one computer processor, a plurality of video items on a plurality of instances of the virtual racer car model representing the real-world racer car to fit each video item on each respective instance of the virtual racer car model for each respective geographical location of each respective user device;
calculating, by the at least one computer processor, a position and a speed of each controllable virtual racer car in the virtual coordinates of the plurality of virtual racetracks based on the control data of each user device;
generating, by the at least one computer processor, in the display device associated with each respective user device, a respective visual representation of the mixed-reality race game comprising each respective controllable virtual racer car in at least of the plurality of virtual racetracks of the plurality of virtual racing environment.

15. A system for mixed-reality race game, the system comprising a computer system comprising instructions which when executed on at least one processor of the computer system cause the computer system to perform mixed-reality race game, and a user device connectable to the computer system, wherein the computer system is configured to:
provide a virtual racing environment comprising a virtual racetrack, the virtual racetrack being a virtual representation of a real-world racetrack;
provide a virtual racer car model representing a real-world racer car;
provide a controllable virtual racer car;
receive telemetry data from at least one sensor associated with the real-world racer car moving on the real-world racetrack, the telemetry data comprising at least position data and motion data of the real-world racer car;
calculate virtual coordinates configured to represent a position in the virtual racetrack based at least in part on the telemetry data of the real-world racer car to associate the telemetry data of the real-world racer car with the virtual racer car model;
receive, from a user device, control data associated with the controllable virtual racer car, and user data comprising geolocation information of the user device the geolocation information defining geographical location of the user device;
obtain a video item associated with the geolocation information and the real-world racer car;
fit the video item on the virtual racer car model representing the real-world racer car;
calculate a position and a speed of the virtual racer car model in the virtual coordinates of the virtual racetrack based on the telemetry data;
calculate a position and a speed of the controllable virtual racer car in the virtual coordinates of the virtual racetrack based on the control data;
generate, in a display device associated with the user device, a visual representation of the mixed-reality race game comprising the controllable virtual racer car in the virtual racetrack, wherein the visual representation is generated at least partly based on the position and the speed of the virtual racer car model and the position and the speed of the controllable virtual racer car in the virtual coordinates.

16. A system according to claim 15, further comprising a real-world racer car comprising one or more sensors configured to detect parameters of the real-world racer car, and to generate the telemetry data based on the detected parameters, the detected parameters comprising at least position and motion of the real-world racer car detected by the one or more sensors.

17. A system according to claim 15, wherein the user device comprises one or more input devices configured to generate the control data as a response to user input.

18. A system according to claim 15, further comprising:
one or more environmental sensors provided in connection with the real-world racetrack and configured to generate environmental measurement data; and
wherein the computer system is configured to:
receive the environmental measurement data from one or more environmental sensors, calculate racetrack data by utilizing the environmental measurement data, and
determine virtual racing environment characteristics of the virtual racing environment or virtual racetrack characteristics of the virtual racetrack based on the calculated racetrack data.

19. A system according to claim 15, further comprising at least one of:
a display device configured to present the visual representation of the mixed-reality race game; or
the user device comprises a display device configured to present the visual representation of the mixed-reality race game.

20. A system according to claim 15, wherein
the virtual racetrack comprise positioning data configured to define positions in the virtual racetrack, the positioning data comprising real-world coordinates configured to associate corresponding positions in the real-world racetrack with the defined positions in the virtual racetrack; or
the virtual racetrack comprises positioning data defining positions in the virtual racetrack, the positioning data comprises the virtual coordinates configured to represent positions in the virtual racetrack and real-world coordinates configured to represent positions in the real-world racetrack, the positioning data being configured to associate virtual coordinates with corresponding real-world racetrack,
the virtual racetrack comprises positioning data comprising spatial mapping data configured to define positions of the virtual racetrack and corresponding real-world positions in the real-world racetrack.

21. A system according to claim 15, wherein the computer system is further configured to:
provide a plurality of virtual racing environments comprising the virtual racing environment, and comprising a plurality of virtual racetracks, the plurality of virtual racetrack being a plurality of virtual representations of the real-world racetrack;
provide a plurality of virtual racer car models representing a real-world racer car, the plurality of virtual racer car model comprising the virtual race car model;
provide a plurality of controllable virtual racer cars associated with a plurality of user devices, the plurality of controllable virtual racer cars comprising the controllable virtual racer car, and the plurality of user devices comprising the user device;
fit a plurality of video items on a plurality of instances of the virtual racer car model representing the real-world racer car to fit each video item on each respective instance of the virtual racer car model for each respective geographical location of each respective user device;
calculate a position and a speed of each controllable virtual racer car in the virtual coordinates of the plurality of virtual racetracks based on the control data of each user device;
generate, in a display device associated with each respective user device, a respective visual representation of the mixed-reality race game comprising each respective controllable virtual racer car in at least of the plurality of virtual racetracks of the plurality of virtual racing environment.

22. A non-volatile computer-readable medium comprising program instructions stored thereon which, when executed on a computer system, cause the computer system to perform a computer-implemented method for a mixed-reality race game, the method comprising:
providing a virtual racing environment comprising a virtual racetrack, the virtual racetrack being a virtual representation of a real-world racetrack;
providing a virtual racer car model representing a real-world racer car;
providing a controllable virtual racer car associated with a user device;
receiving telemetry data from at least one sensor associated with the real-world racer car moving on the real-world racetrack, the telemetry data comprising at least position data and motion data of the real-world racer car;
calculate virtual coordinates configured to represent a position in the virtual racetrack based at least in part on the telemetry data of the real-world racer car to associate the telemetry data of the real-world racer car with the virtual racer car model;
receiving, from a user device, control data associated with the controllable virtual racer car, and user data comprising geolocation information of the user device the geolocation information defining geographical location of the user device;
obtaining a video item associated with the geolocation information and the real-world racer car;
fitting the video item on the virtual racer car model representing the real-world racer car to fit each video item on an instance of the virtual racer car model for the geographical location of the user device;
calculating a position and a speed of the virtual racer car model in the virtual coordinates of the virtual racetrack based on the telemetry data;
calculating a position and a speed of the controllable virtual racer car in the virtual coordinates of the virtual racetrack based on the control data;
generating, in a display device associated with the user device, a visual representation of the mixed-reality race game comprising the controllable virtual racer car in the virtual racetrack, wherein the visual representation is generated at least partly based on the position and the speed of the virtual racer car model and the position and the speed of the controllable virtual racer car in the virtual coordinates.
